(19) United States
(12) Patent Application Publication
(10) Pub. No.: US 2026/0138212 A1
(43) Pub. Date: May 21, 2026

(54) NOZZLE UNIT FOR A LASER PROCESSING HEAD FOR LATERAL PROTECTIVE GAS SUPPLY AND LASER PROCESSING HEAD WITH THE SAME

(71) Applicant: Precitec GmbH & Co. KG, Gaggenau (DE)

(72) Inventors: Steffen Boley, Leonberg (DE); Felicitas Kunz, Karlsruhe (DE)

(73) Assignee: Precitec GmbH & Co. KG, Gaggenau (DE)

(21) Appl. No.: 19/389,901

(22) Filed: Nov. 14, 2025

(30) Foreign Application Priority Data
Nov. 18, 2024 (DE) 10 2024 133 695.1

(51) Int. Cl. B23K 26/14

(52) U.S. Cl. CPC B23K 26/1482; B23K 26/1464

(57) ABSTRACT

A nozzle unit that lateral shields gas supply for a laser machining head. The nozzle unit includes a shielding gas nozzle, a holding device to which the shielding gas nozzle is attached, and an adapter for attaching the holding device to the laser machining head. The holding device and the adapter are detachably coupled to each other by magnetic force.

### CROSS-REFERENCE TO RELATED APPLICATION

This application claims priority to German Patent Application No. 102024 133 695.1 filed on November 18, 2024, which is herein incorporated by reference in its entirety.

### TECHNICAL FIELD

The present disclosure relates to a nozzle unit for lateral shielding gas supply for a laser machining head, in particular for a laser welding head, and a laser machining head, in particular a laser welding head, comprising such a nozzle unit.

### BACKGROUND

Laser cladding (hereinafter also referred to as "cladding") is an additive manufacturing process in which a cladding material is fed into a machining zone on a workpiece, for example a metallic workpiece, is melted by a laser beam, and is bonded, in particular welded, to the workpiece. A laser welding head emits a laser beam from a laser source or the end of a laser guide fiber into the machining zone on the workpiece. If the filler material is supplied as wire, this process may also be referred to as (laser) wire cladding. In this case, a wire guide device, for example, feeds the wire (also known as welding wire) into the machining zone.

In laser machining, especially in laser welding or laser cladding, it is desirable to feed a shielding gas into the machining zone in order to shield the material of the workpiece or the filler material from the ambient atmosphere, for example. The shielding gas may be supplied coaxially. In this case, the shielding gas flow is at least partially rotationally symmetrical to the beam axis of the laser beam. The shielding gas may also be supplied laterally or sideways. In this case, the shielding gas is fed into the machining zone outside the beam axis of the laser beam or at an angle to the beam axis.

For lateral shielding gas supply, a shielding gas nozzle located outside the housing of the laser machining head or attached to the side of the housing of the laser machining head is usually used. Here, the shielding gas nozzle must be protected against collisions with other objects, such as the workpiece, welded structures, or elements of a laser machining system. Collisions may refer to unintentional contact between the machining gas nozzle and other objects, in particular the workpiece. The protection is necessary in order to protect the machining gas nozzle, the laser machining head, the workpiece, and the machine from damage due to collisions.

### SUMMARY

It is an object of the present disclosure to provide an improved nozzle unit for lateral shielding gas supply for a laser machining head, in particular a laser welding head.

In particular, it is an object of the present disclosure to provide a nozzle unit with improved collision protection. In particular, it is an object to provide a nozzle unit that prevents damage to a shielding gas nozzle in the event of a collision with another object.

It is also an object of the present disclosure to provide a nozzle unit with improved adjustability. It is also an object of the present disclosure to provide a nozzle unit that has improved adaptability to different diameters of the shielding gas nozzle.

It is also an object to provide a laser machining head, in particular a laser welding head, comprising such a nozzle unit.

At least one of these objects is achieved by the subject matter of the claims.

The present disclosure is based on the realization that conventional shielding gas nozzles are rigidly connected to the laser machining head. In addition, conventional nozzle units are often configured as a rigid component, i.e., a component in which all elements are firmly connected to each other. The basic idea of the present disclosure is to attach a shielding gas nozzle to the laser machining head in such a way that the connection can be released in the event of a collision of the shielding gas nozzle with an obstacle or in the event of an (unintended) external force acting on the shielding gas nozzle. This prevents the shielding gas nozzle from being bent and thus being damaged or even destroyed. According to the present disclosure, two elements of the nozzle unit are magnetically coupled to each other in such a way that the shielding gas nozzle can be detachably coupled or attached to a laser machining head. In the present disclosure, "detachable" means "reversibly detachable." In addition, this allows for easy replacement of parts of the nozzle unit, in particular the shielding gas nozzle itself.

According to a first aspect of the present disclosure, a nozzle unit for lateral shielding gas supply to a laser machining head is provided, said nozzle unit comprising: a shielding gas nozzle, a holding device to which the shielding gas nozzle is attached, and an adapter for attaching the nozzle unit to the laser machining head. The holding device and the adapter are detachably coupled to each other by magnetic force. The coupling of the holding device and the adapter by magnetic force may also be referred to as magnetic coupling.

According to a further aspect of the present disclosure, a laser machining head is provided, comprising: a housing, and a nozzle unit according to an aspect or according to an embodiment of the present disclosure, wherein the adapter is attached to the housing, in particular to an outer side and/or to a projection of the housing.

Aspects and embodiments of the present disclosure may have one or more of the following optional features.

The holding device is thus detachably coupled to or detachably connected to the adapter. In this way, in the event of a collision or an external force acting on the shielding gas nozzle with an object, the shielding gas nozzle (and the holding device) can detach from the laser machining head independently of other components of the laser machining head, such as a wire feed.

The shielding gas nozzle may be detachably attached to the holding device or may be permanently connected to the holding device. The shielding gas nozzle and the holding device may be configured as a single piece and/or may be configured as a wear part.

The housing may have a flange, an outwardly protruding edge, and/or a projection for attaching the adapter or the nozzle unit.

The adapter may be detachably attached to the housing, in particular to a flange, an outwardly protruding edge, and/or a projection of the housing. The adapter may be configured for detachably attaching the nozzle unit or the holding device to the housing of the laser machining head, for example by a screw connection or bolt connection or clamp connection. The adapter may be configured as a clamp, in particular as a C-clamp and/or as a screw clamp.

A magnitude or strength of the magnetic force may be selected such that the adapter and the holding device detach from each other when a predetermined external force (e.g., on the shielding gas nozzle) is applied. The predetermined external force may specify or be an external force with a predetermined value and/or in a predetermined direction. The predetermined external force may be an unintentional or unwanted or sudden external force. The external force may result from a collision of the shielding gas nozzle with another object, in particular the workpiece, and may be transferred to other elements of the nozzle unit, for example to the holding device or the adapter. When determining whether an external force is present, the magnetic force and/or gravitational force that normally acts on the holding device with the shielding gas nozzle in the coupled state can be neglected. The magnitude of the magnetic force may be selected such that the gravitational force acting on the holding device and the shielding gas nozzle (in particular in the coupled state) does not result in the magnetic coupling being released.

The release of the magnetic coupling may mean that the holding device and the adapter, in particular a magnet unit and a coupling region, in particular a coupling surface of the coupling region and a magnet pot or magnet arranged therein of the magnet unit, move so far apart that the coupling magnetic force is overcome by other forces, for example the gravitational force acting on the holding device and the shielding gas nozzle and the force acting from outside. After the magnetic coupling has been released, the adapter and the holding device, in particular the coupling surface and the magnet pot, can be separated from each other or no longer touch each other.

The release ensures that the holding device can detach from the adapter in the event of a collision of the nozzle unit or the shielding gas nozzle. This prevents elements of the nozzle unit, in particular the shielding gas nozzle or the holding device, from being bent and damaged due to the external force.

One of the adapter and the holding device may be configured as a magnetic unit, and the other of the adapter and the holding device may be configured as a ferromagnetic unit. The magnetic unit and the ferromagnetic unit may provide the magnetic force for coupling the adapter and the holding device. The magnetic unit may comprise a magnet. The magnet unit may further comprise a magnet pot in which the magnet is arranged. The ferromagnetic unit may comprise a coupling region for magnetic coupling with the magnet unit. The ferromagnetic unit and/or the coupling region may comprise a ferromagnetic portion made of ferromagnetic material or consist of ferromagnetic material.

The magnet may have a rectangular cross-section and/or be cube-shaped. The magnet may be rotationally symmetrical and/or cylinder-shaped. The magnet pot may be configured as a hollow cylinder open on one side and/or have an opening. The magnet pot may have a cross-sectional shape (perpendicular to a direction of the magnetic force or perpendicular to the coupling surface in the coupled state) corresponding to the cross-sectional shape of the magnet. The magnet may be inserted into the magnet pot. The magnet pot may be ferromagnetic and/or may consist of a ferromagnetic material. The magnet may be attached to the magnet pot, in particular to a bottom of the magnet pot. The magnet may be glued into the magnet pot. Alternatively, the magnet may be attached to the magnet pot solely by magnetic force. In this case, the magnetic force for attaching the magnet in the magnet pot may be greater than the magnetic force for coupling the magnet unit to the ferromagnetic unit. The depth of the magnet pot may be equal to or greater than the height of the magnet. One end face of the magnet may be flush with one end face of the magnet pot.

The magnet unit may comprise a positioning element. A shape of the coupling region and a shape of the positioning element may be adapted to each other and/or the magnitude of the magnetic force may be selected such that the magnet unit is coupled to the ferromagnetic unit in a predetermined orientation, in particular without external force, by the magnetic force. A shape of the coupling region and a shape of the positioning element may be adapted to each other and/or the magnitude of the magnetic force may be selected such that the ferromagnetic unit automatically orients itself or centers itself or positions itself in the predetermined orientation (so-called auto-orientation or auto-centering or auto-positioning). This makes it possible to position the holding device or the magnet unit in the predetermined orientation at all times without any effort.

The coupling region and the positioning element may be inserted into each other and/or may engage with each other. The positioning element may be formed on the magnet pot, in particular on an edge of the magnet pot. The positioning element may be formed on an end face of the magnet unit, in particular on an end face of the magnet pot (or the edge of the magnet pot), and/or on an outer side of the magnet unit, in particular on an outer side of the magnet pot (or the edge of the magnet pot). The positioning element may be formed integrally with the magnet unit or the magnet pot or the edge. The edge of the magnet pot may enclose the opening of the magnet pot. The edge of the magnet pot may comprise the end face of the magnet pot. The end face may form part of the edge.

The coupling region may comprise a coupling surface. The coupling surface may be opposite the magnet unit, in particular the magnet pot and/or the magnet. The coupling surface may be planar.

The coupling surface and the end face of the magnet pot and/or the end face of the magnet may touch each other in the coupled state. The coupling surface may comprise or consist of ferromagnetic material for magnetic coupling with the magnet unit. The magnetic force for coupling the holding device and the adapter may act between the ferromagnetic unit and the magnet unit, in particular between the coupling region (or the coupling surface of the coupling region) and the magnet and/or the magnet pot. The magnetic force may be perpendicular to the coupling surface.

"Coupled in a predetermined orientation" may mean that rotation of the magnet unit about an rotational axis perpendicular to the coupling surface of the coupling region is prevented or restricted up to the predetermined external force, in particular without releasing the magnetic coupling of the adapter and the holding device. Here, the predetermined external force may specify an external force in a predetermined first direction with a predetermined value. The rotation of the magnet unit may also be defined about a rotational axis parallel to the magnetic force and/or coaxial with the axis of the magnet pot and/or the magnet. In the case of an external force in the predetermined first direction and at or above the predetermined value, rotation of the magnet unit about the rotational axis perpendicular to the coupling surface may be allowed and/or the magnetic coupling may be released.

Tilting of the magnet unit about an axis parallel to the coupling surface of the coupling region may be allowed when a predetermined external force is applied. The predetermined external force may be an external force in a predetermined second direction with a predetermined value (magnitude) greater than zero. The tilting of the magnet unit may be defined about an axis perpendicular to the magnetic force or to the center axis or axis of symmetry of the magnet pot and/or the magnet. The predetermined external force may generally be an external force acting on the magnet unit.

The coupling region may be formed as a recess in the ferromagnetic unit. The recess may also be referred to as an inner groove. The recess may comprise the coupling surface. The recess may comprise an edge delimiting the coupling surface. The edge of the magnet pot may be inserted into the recess, in particular when the adapter and the holding device are coupled to each other. The recess and/or the edge of the magnet pot may be non-rotationally symmetrical in shape. The recess and/or the edge of the magnet pot may have a circumference that is not rotationally symmetrical in shape. The recess and/or the edge of the magnetic pot may be formed with a circular circumference with the exception of at least one circumferential portion shaped differently. The circumferential region shaped differently may be straight and/or may have the shape of a chord. A region of the edge of the magnet pot that deviates from rotational symmetry, or the circumferential region of the edge of the magnet pot shaped differently, may be regarded as the positioning element.

The positioning element may be configured as a positioning lug. The positioning lug may be configured as a protruding or elevated element. The positioning lug may protrude from an end face and/or outer side of the magnet unit (in particular the magnet pot). The coupling region, in particular the coupling surface, may have a correspondingly shaped recess into which the positioning lug is inserted (in the coupled state). The positioning lug may be prismatic in shape. The positioning lug may taper with increasing distance from the magnet unit or the magnet pot. The base of the prism may be located on the end face of the magnet unit or the magnet pot. The positioning lug may taper from the base with increasing distance from the end face.

The positioning lug may have two opposite side surfaces. In embodiments, the two side surfaces may each form an angle of less than 90° or less than 75°, or approximately 45°, with a plane perpendicular to the axis of symmetry of the magnet pot, and/or the side surfaces may form support surfaces for support in the recess of the coupling region. The two side surfaces may converge with increasing distance from the magnet unit or the magnet pot. The positioning lug may have a trapezoidal cross-section. A surface normal of each of the side surfaces may extend perpendicular to the radial direction of the magnet pot and/or the magnet. The surface normals of both side surfaces may be arranged in a plane.

The recess of the coupling region may be shaped so as to correspond to the positioning lug. The recess of the coupling region may be prismatic in shape. Side surfaces of the recess may form contact surfaces or friction surfaces for shearing the magnet unit from the coupling region. The support of the positioning lug in the recess of the coupling region (or the support of the two side surfaces of the positioning lug on the contact surfaces) may in total be regarded as a support point.

The recess of the coupling region may be open on a side corresponding to an outer side of the magnet pot. The recess of the coupling region and the positioning lug may each be formed at a position that is furthest down in the direction of gravity when the adapter is attached to the laser machining head and the holding device and the adapter are coupled to each other and/or that is closest to the workpiece during operation of the laser machining head. The position of the recess may be located at a lower region of the edge of the coupling region.

According to alternative embodiments, the positioning element or positioning lug may be formed on the coupling region and the recess may be formed on the magnetic unit. The above applies accordingly where applicable.

The magnet unit may be in contact with the ferromagnetic unit at three support points. "In contact" is to be understood in the present disclosure as synonymous with "touching." The positioning element or the two support surfaces of the positioning element may form a support point. The magnet unit may have two further support elements, each of which forms a support point. The support elements may be arranged on the end face of the magnet unit (in particular the magnet pot) and/or may protrude from the end face. The support elements may rest on the coupling surface when the magnet unit and the ferromagnetic unit are coupled. Alternatively, the support elements may also be formed on the coupling surface. Such a three-point support can provide a tilt-stable support for the magnet unit on the coupling surface.

The holding device may further comprise a clamping device by which the shielding gas nozzle is detachably attached to the holding device. The clamping device may be adjustable to different diameters of the shielding gas nozzle. This allows the nozzle unit to be adjustable for shielding gas nozzles of different diameters, depending on the application.

The shielding gas nozzle may be configured as a tube or may comprise a tube. The tube may have a substantially cylindrical portion and/or may have a tapered end. The tapered end may have two flat cut sides. The shielding gas nozzle or tube may consist of or comprise metal, in particular copper.

The clamping device may have a first clamping element with a first, in particular V-shaped, notch and a second clamping element with a second, in particular V-shaped, notch. The first notch and the second notch may be opposite each other along a predetermined direction. The two clamping elements may be displaceable relative to each other along the predetermined direction in order to clamp the shielding gas nozzle between the clamping elements. The clamping device allows for shielding gas nozzles with different diameters to be used. The shielding gas nozzle may be clamped between the V-shaped notches.

The first clamping element may be connected to the magnet unit, in particular to the magnet pot. The first and/or second notch may initially be parallel and then V-shaped.

The holding device may further comprise an adjustment device. The adjustment device may be used to adjust the position of the shielding gas nozzle relative to the adapter and/or relative to the housing of the laser machining head and/or relative to the beam propagation direction of the laser beam and/or relative to the magnet unit. The adjustment device may be configured as a plate with an elongated hole. This allows for the adjustment device or the position of the shielding gas nozzle to be adjusted in the direction of the elongated hole. The adjustment device may be detachably attached to the magnet unit by a clamping screw of the holding device. The adjustment device may in turn be firmly connected to the clamping device or the shielding gas nozzle.

The laser machining head may be configured to radiate the laser beam into a machining zone on the workpiece. The laser machining head may include at least one optical element for beam guidance and/or beam shaping. In particular, the laser machining head may comprise focusing optics for focusing the laser beam onto the workpiece. In addition, the laser machining head may comprise collimating optics for collimating the laser beam. The laser machining head may comprise a housing. The focusing optics and the collimating optics may be arranged inside the housing. The housing of the laser machining head may define an optical space of the laser machining head.

The laser machining head may be configured as a laser welding head. The laser machining head may be suitable and/or configured for laser machining, in particular for laser welding, in embodiments, for laser cladding, of the workpiece.

Furthermore, the laser machining head may comprise a wire guide device for feeding a welding wire into the machining zone on the workpiece. The welding wire may be fed, at least in sections, concentrically to the laser beam. This may mean that a wire guide direction of the welding wire and a beam propagation direction of the laser beam extend, at least in sections, coaxially with each other. In addition, the laser machining head may comprise at least one further optical element, for example an axicon and/or a prism, for forming an annular laser beam and/or for concentrically radiating the laser beam with the welding wire into the machining zone on the workpiece.

The workpiece may be a metallic workpiece. The cladding material and/or the material of the welding wire may comprise or consist of a metallic material.

The at least one magnet may retain its magnetic force even at a temperature of more than 100°C, for example at 200°C. The at least one magnet may comprise AlNiCo, neodymium, samarium, and/or cobalt, or consist of or comprise a samarium-cobalt alloy. This ensures that the magnet retains its magnetic force even at high temperatures, such as those generated during laser cladding in the machining zone on the workpiece.

### BRIEF DESCRIPTION OF THE FIGURES

Embodiments of the present disclosure are illustrated in the figures and are described in detail below. In the figures:

FIG. 1 shows a schematic view of a laser machining head with a nozzle unit according to embodiments of the present disclosure;

FIG. 2A shows a schematic cross-sectional view of a nozzle unit according to embodiments of the present disclosure;

FIG. 2B shows a schematic perspective view of a nozzle unit according to embodiments of the present disclosure;

FIG. 3A shows a schematic top view of the nozzle unit according to embodiments of the present disclosure, wherein a shielding gas nozzle has been removed;

FIG. 3B shows a schematic top view of the nozzle unit according to embodiments of the present disclosure, wherein a shielding gas nozzle has been removed;

FIG. 4A shows a schematic perspective view of an adapter of a nozzle unit according to a first embodiment of the present disclosure;

FIG. 4B shows a schematic perspective view of a magnet unit of a nozzle unit according to a first embodiment of the present disclosure;

FIG. 5A shows a schematic perspective view of an adapter of a nozzle unit according to a second embodiment of the present disclosure;

FIG. 5B shows a schematic perspective view of a magnet unit of the nozzle unit according to the second embodiment of the present disclosure;

FIG. 5C shows a schematic bottom view of the adapter of the nozzle unit according to the second embodiment of the present disclosure;

FIG. 5D shows a schematic bottom view of the magnet unit of the nozzle unit according to the second embodiment of the present disclosure;

FIG. 6 shows a schematic perspective view of an end of a shielding gas nozzle according to embodiments of the present disclosure.

### DETAILED DESCRIPTION

Hereinafter, unless otherwise specified, the same reference symbols are used for identical and equivalent elements. The directions x, y, and z shown in the figures are coordinate axes of a Cartesian coordinate system.

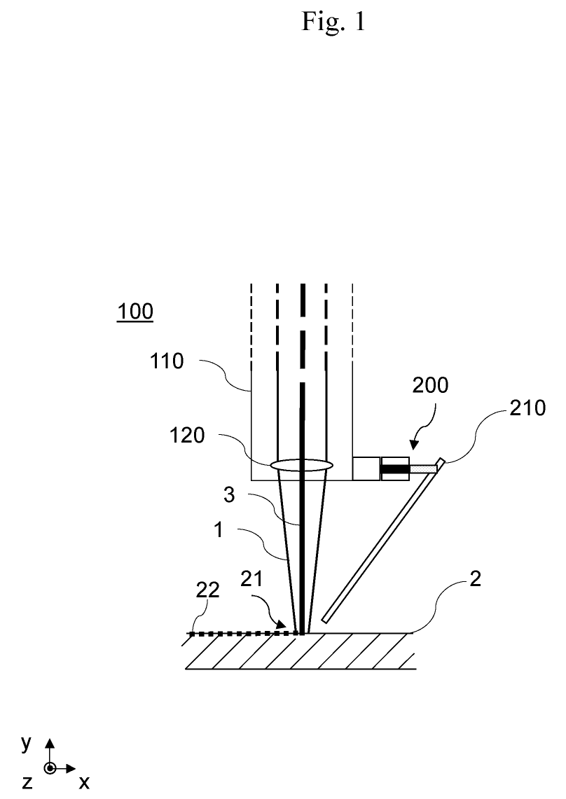

FIG. 1 shows a schematic view of a laser machining head with a nozzle unit according to embodiments of the present disclosure.

The laser machining head 100 is used in particular for cladding by a laser beam 1 (laser cladding) and may therefore also be referred to as a laser welding head. In laser cladding, the cladding material is fed into a machining zone 21 on a workpiece 2 in the form of a wire 3. At the same time, the laser beam 1 is radiated into the machining zone 21. As a result, the supplied wire 3 is melted and bonded to the workpiece 2. By moving the machining zone 21, for example by moving the laser machining head 100 along a feed direction, for example along the x-direction, a weld seam 22 is created. The weld seam 22 may be used to join a plurality of workpieces. In addition or alternatively, structures may be formed on the workpiece 2.

As shown, a beam propagation direction or beam axis of the laser beam 1 extends in parallel to the y-direction. The wire is guided along a wire guide direction that extends coaxially with the beam propagation direction. The laser machining head 100 comprises optical elements for beam guidance and shaping, for example lenses, objectives, mirrors, prisms, axicons, etc. A focusing lens 120 for focusing the laser beam 1 onto the workpiece 2 is shown. The laser machining head 100 may also comprise a collimating lens (not shown) for collimating the laser beam 1. The laser machining head 100 may comprise further optical elements not shown. These further optical elements may include one or more axicons for annularly shaping the laser beam 1. In addition, the laser machining head 100 may comprise one or more prisms for splitting the laser beam 1 into a plurality of parts and one or more mirrors for guiding the laser beam 1 around the wire 3. "Annular" may also mean that the laser beam 1 has a radially symmetric, in particular a rotationally symmetric, shape with respect to the beam propagation direction.

In addition, a laser source (not shown) may be provided for generating the laser beam 1. The laser beam may be fed to the laser machining head 100 through an optical fiber (also not shown). Furthermore, a displaying device (not shown) configured to adjust the position of the laser machining head 100 relative to the workpiece 2, in particular to move the laser machining head 100 along the feed direction, may be provided. The workpiece 2 or workpieces may be configured as plate-shaped and/or metallic workpieces.

The laser machining head 100 comprises a housing 110 in which the optical elements are received. Furthermore, the laser machining head 100 comprises a nozzle unit 200 for lateral shielding gas supply according to embodiments of the present disclosure. The nozzle unit 200 comprises a shielding gas nozzle 210. The nozzle unit 200 is attached to the housing 110, in particular to the outside of the housing 110. The nozzle unit 200 may in particular be attached to a flange or projection (not shown) of the housing 110. The attachment may be releasable. The nozzle unit 200 may be arranged at a lower end, i.e., an end of the housing 110 opposite the workpiece 2, as shown.

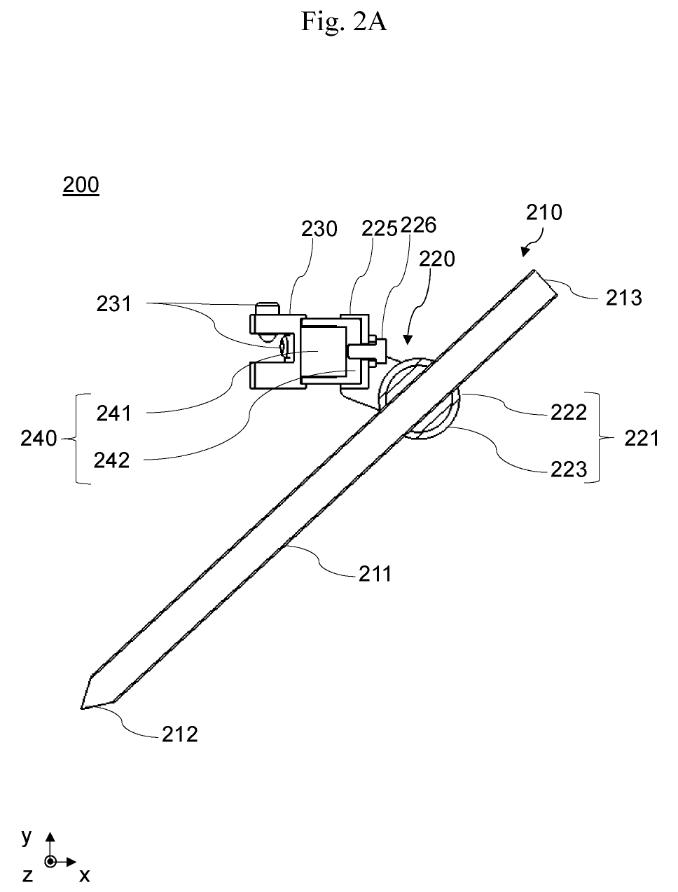

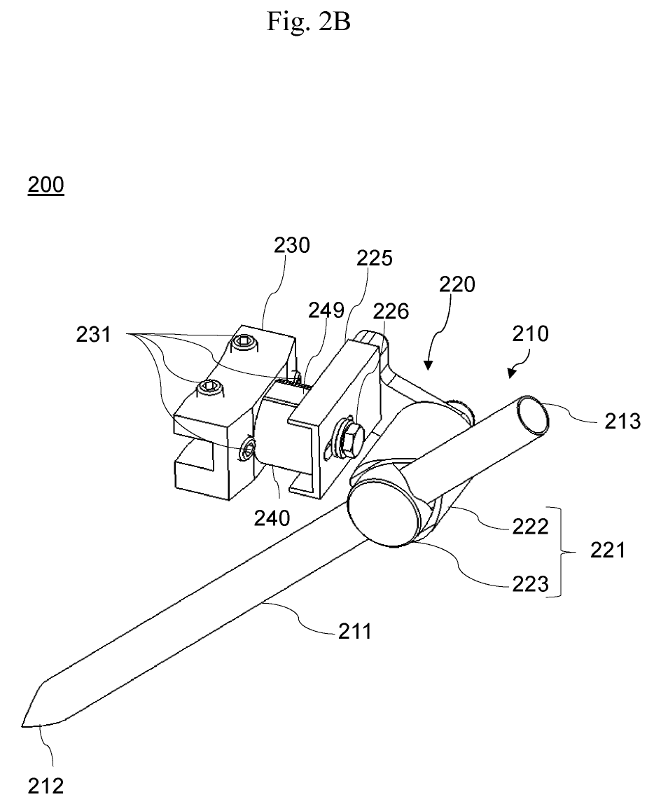

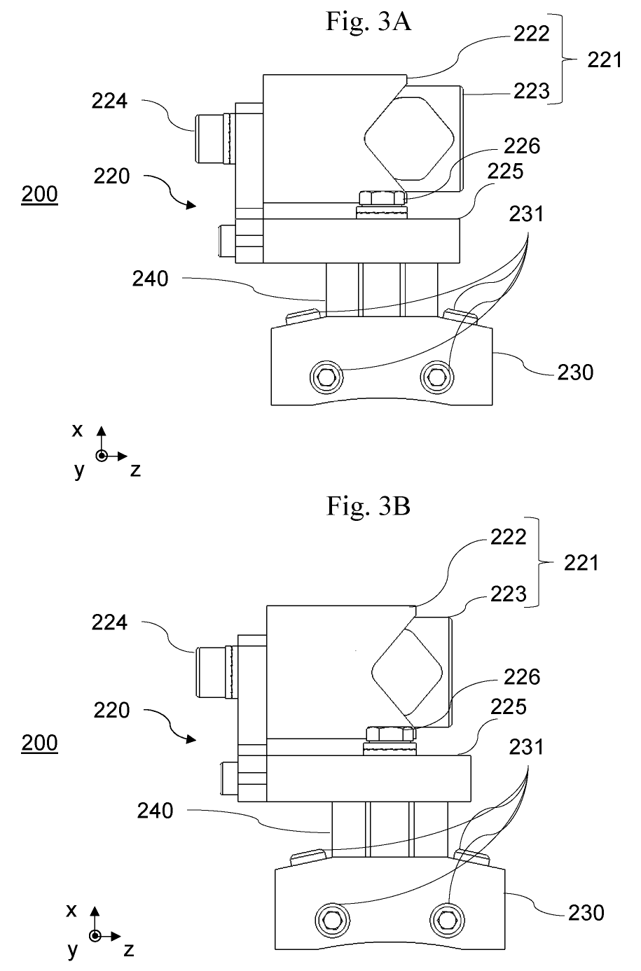

FIG. 2A shows a schematic cross-sectional view in the x-y plane of a nozzle unit according to embodiments of the present disclosure. FIG. 2B shows a schematic perspective view of the nozzle unit. FIG. 3A and FIG. 3B each show a top view of the nozzle unit with the shielding gas nozzle removed.

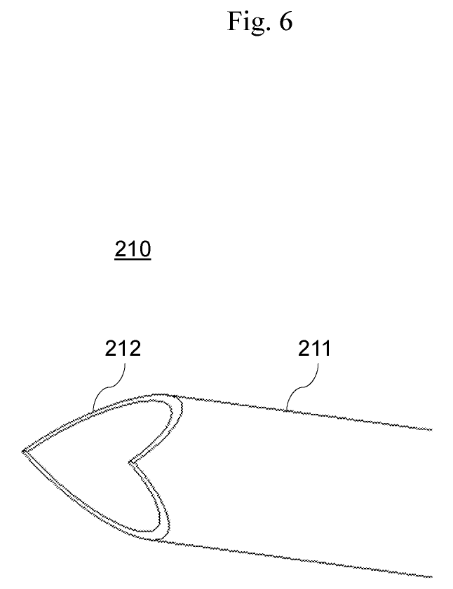

The nozzle unit 200 comprises the shielding gas nozzle 210. The shielding gas nozzle 210 is formed as a tube. The tube comprises a substantially cylindrical portion 211 with a first end 213 and a tapered second end 212. The shielding gas (not shown) exits from the second end 212 and is supplied to the first end 213 of the cylindrical portion 211 of the shielding gas nozzle 210. The tube 210 may be made of copper, for example. FIG. 6 shows a schematic perspective view of the second end 212 of the cylindrical portion 211 of the shielding gas nozzle 210 according to embodiments of the present disclosure. As shown, the cylindrical portion 211 is cut flat at an angle on two sides, in embodiments, opposite each other with respect to the central axis of portion 211, to form the tapered second end 212. The second end 212 may thus be symmetrical, in particular rotationally symmetrical.

Furthermore, the nozzle unit 200 comprises a holding device 220 for holding the shielding gas nozzle 210. As shown, the shielding gas nozzle 210 is attached to the holding device 220 via the cylindrical portion 211, for example by clamping.

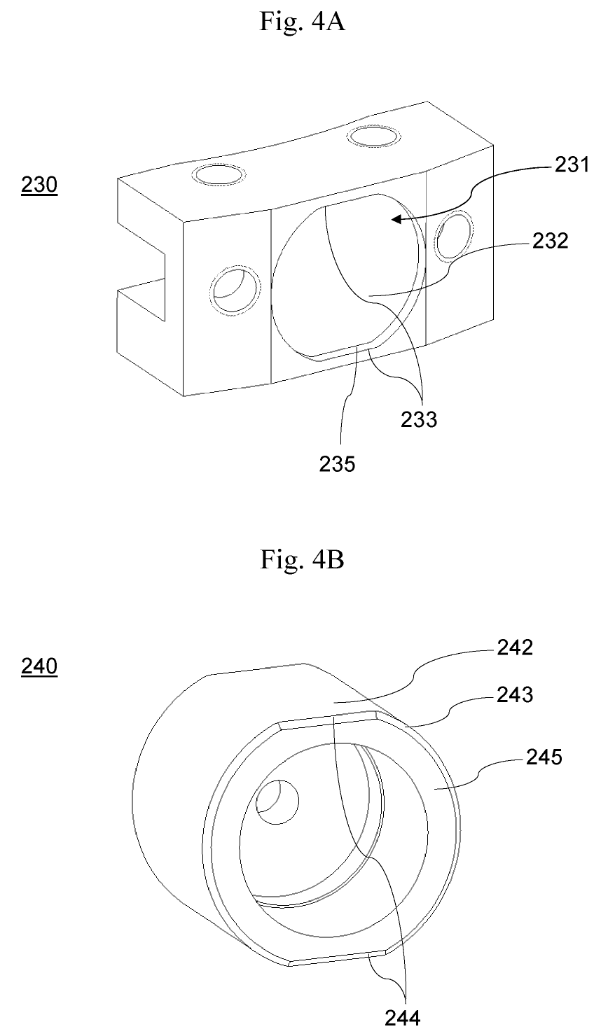

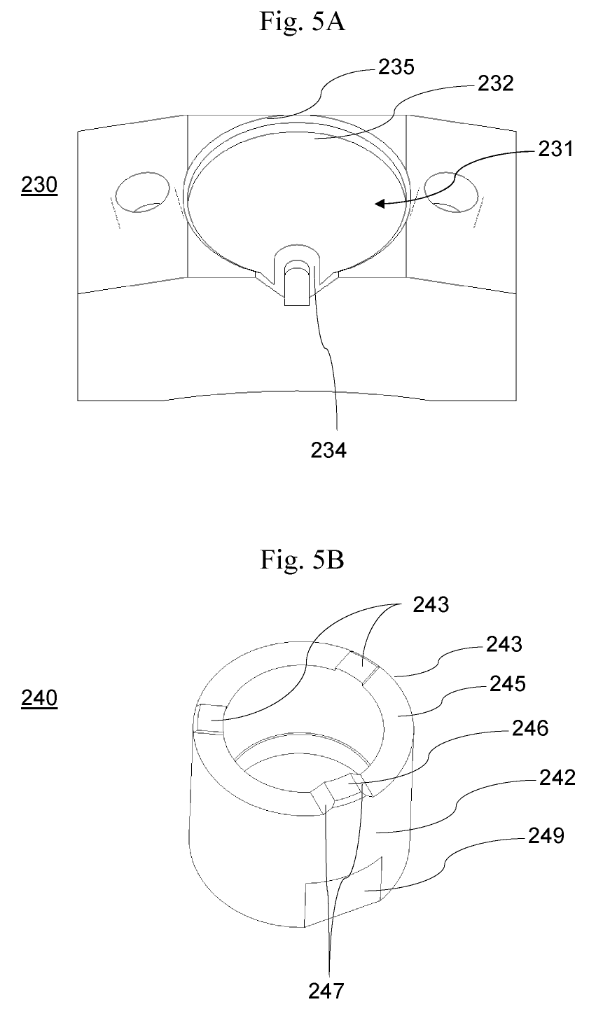

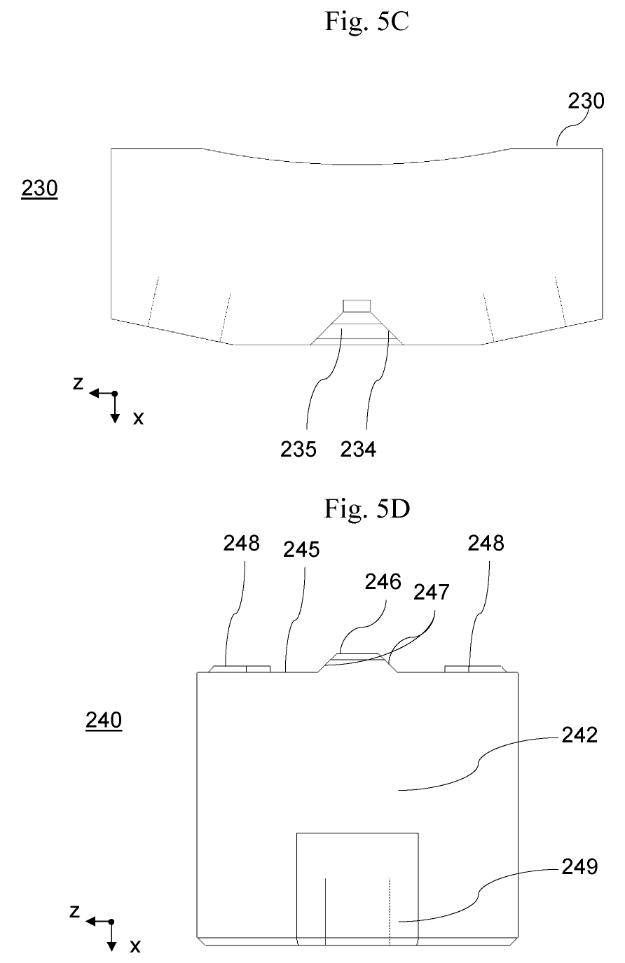

In addition, the nozzle unit 200 comprises an adapter 230 for attaching the nozzle unit 200 or the holding device 220 to the laser machining head 100. The holding device 220 and the adapter 230 are detachably coupled to each other by magnetic force. The holding device 220 comprises a magnet unit 240 and the adapter 230 comprises a ferromagnetic unit. Although the following description with reference to the figures describes that the holding device comprises the magnet unit and the adapter comprises the ferromagnetic unit, the present disclosure is not limited thereto. The holding device may also comprise the ferromagnetic unit and the adapter may comprise the magnet unit. The magnetic coupling, the magnet unit 240, and the ferromagnetic unit are described in detail later with reference to FIGS. 4A to 5D.

The magnitude of the magnetic force is selected such that the magnetic coupling of the adapter 230 and the holding device 220 is released when a predetermined external force is applied to the holding device 220 or the shielding gas nozzle 210. The external force may result from a collision of the shielding gas nozzle 210 with another object, in particular the workpiece. The magnitude of the magnetic force is selected such that the gravitational force acting on the holding device 220 and the shielding gas nozzle 210 does not result in the release of the magnetic coupling. This ensures that the holding device 220 can detach from the adapter 230 in the event of a collision between the nozzle unit 200 or the shielding gas nozzle 210.

The adapter 230 may be detachably attached to the housing 110 of the laser machining head 100. For this purpose, the adapter 230 may be configured as a C-clamp or screw clamp, as shown, into which the flange or projection of the housing 110 is inserted. For detachable attachment of the adapter 230 or the nozzle unit 200 as a whole to the housing 110, the adapter 230 comprises one or more screws or bolts 231.

The holding device 220 further comprises a clamping device 221 by which the shielding gas nozzle 210 may be detachably or interchangeably fastened to the holding device 220. The clamping device 221 is adjustable to different diameters of the shielding gas nozzle 210, in particular the cylindrical portion 211 of the shielding gas nozzle 210. This allows the nozzle unit 200 to be adjusted and used for shielding gas nozzles of different diameters, depending on the application. FIG. 3A shows an adjustment of the clamping device 221 for a shielding gas nozzle 210 with a relatively larger diameter, FIG. 3B shows an adjustment of the clamping device 221 for a shielding gas nozzle 210 with a relatively smaller diameter.

The clamping device 221 comprises a first clamping element 222 and a second clamping element 223. Each of the clamping elements 222, 223 comprises a notch at its end, which is V-shaped or at least comprises a V-shaped portion. The ends of the clamping elements 222, 223 with the notches are opposite each other along a predetermined direction. In FIGS. 3A and 3B, this direction extends along the z-axis. The two clamping elements 222, 223 can be displaced or adjusted relative to each other along the predetermined direction. For example, the second clamping element 223 may be adjustable or can be adjusted relative to the first clamping element 222. For this purpose, the holding device 220 may include a screw 224. By adjusting, the shielding gas nozzle 210 may be clamped between the clamping elements 222, 223.

The holding device 220 further comprises an adjustment device 225. By the adjustment device 225, the position of the shielding gas nozzle 210 relative to the adapter 230 and/or relative to the magnet unit 240 can be adjusted. This allows for the position of the shielding gas nozzle to be adjusted relative to the housing of the laser machining head and/or relative to the beam propagation direction of the laser beam in order to ensure that the shielding gas is fed precisely into the machining zone. As shown, the adjustment device 225 is configured as a plate with an elongated hole. This allows for the adjustment device 225 or the position of the shielding gas nozzle 210 to be adjusted in the direction of the elongated hole. The adjustment device 225 may be detachably attached to the magnet unit 240 by a clamping screw 226 of the holding device 220. The adjustment device 225 is in turn firmly connected to the clamping device 221 or the shielding gas nozzle 210. The magnet unit 245 may have, on the outside, a straight portion 249 for guiding the adjustment device 224.

FIG. 4A shows a schematic perspective view of the adapter of the nozzle unit according to a first embodiment of the present disclosure. FIG. 4B shows a schematic perspective view of the magnet unit of the nozzle unit according to the first embodiment of the present disclosure.

In the embodiment shown, the adapter 230 comprises a ferromagnetic unit or is configured as a ferromagnetic unit. This means that the adapter 230, or at least a coupling region 231 of the adapter 230, consists of or comprises ferromagnetic material. In the embodiment shown, the holding device 220 further comprises a magnet unit 240 with a magnet 241 (FIG. 2A) and a magnet pot 242. FIGS. 4B and 5B show the magnet unit 240 without the magnet 241 for reasons of clarity. The magnet unit 240 and the ferromagnetic unit may provide the magnetic force for magnetically coupling the adapter 230 and the holding device 220.

The magnet 241 is substantially cylindrical in shape and inserted into the magnet pot 242. For example, the magnet 241 may be glued into the magnet pot 242. The magnet pot 242 may also be made of a ferromagnetic material. FIG. 2A shows that the depth of the magnet pot 242 is equal to the height of the magnet 241. However, the present disclosure is not limited thereto. The depth of the magnet pot 242 may also be greater than the height of the magnet 241.

The coupling region 231 is formed as a recess in the ferromagnetic unit. The coupling region 231 or recess comprises a coupling surface 232 and an edge 235. The coupling surface 232 is opposite the magnet unit 240 and is flat. The edge 243 of the magnet pot 242 is inserted into the recess, and the coupling surface 232 and an end face 245 of the magnet pot 240 touch each other when the adapter 230 and the holding device 220 are coupled to each other. The recess or the edge 235 of the recess and the edge 243 of the magnet pot 242 are not rotationally symmetrical in shape. As shown, the recess or the edge 235 of the recess and the edge 243 of the magnet pot 242 have a circular circumference with the exception of at least one circumferential portion 233 or 244 shaped differently. The circumferential region 233, 244 shaped differently may, for example, be straight. As shown, both the recess or the edge 235 of the recess and the edge 243 of the magnet pot 242 have two circumferential portions 233 and 244 shaped differently, respectively. In the case of the edge 243, the circumferential regions 244 shaped differently each form a positioning element.

The shape of the coupling region 231 and the shape of the positioning elements are adapted to each other in such a way that the magnet unit 240 is coupled to the adapter 230 in a predetermined orientation by the magnetic force, in particular without the application of external force.

In this embodiment, tilting of the magnet unit 240 about an axis parallel to the coupling surface 232 (in FIGS. 3A, 3B parallel to the y-z plane) when an external force is applied to the magnet unit 240, for example as a result of a collision of the shielding gas nozzle 210 with an object, is possible.

FIG. 5A shows a schematic perspective view of the adapter of the nozzle unit according to a second embodiment of the present disclosure. FIG. 5B shows a schematic perspective view of the magnet unit of the nozzle unit according to the second embodiment of the present disclosure. FIG. 5C shows a schematic bottom view of the adapter of the nozzle unit according to the second embodiment of the present disclosure. FIG. 5D shows a schematic bottom view of the magnet unit of the nozzle unit according to the second embodiment of the present disclosure.

In this embodiment, the magnet unit comprises a positioning element 246 configured as a positioning lug formed on the end face 245 of the magnet pot 242, wherein the positioning element 246 is formed integrally with the magnet pot 242. The positioning lug protrudes prismatically from the end face 245 of the magnet pot 242. The positioning lug thus tapers from its base on the front side 245 with increasing distance from the front side. The coupling surface 232 comprises a correspondingly shaped recess 234 into which the positioning element 246 is inserted when the adapter 230 and the holding device 220 are coupled to each other.

The positioning lug comprises two opposing side surfaces 247. In embodiments, the two side surfaces 247 each form an angle of less than 90°, or 45°, with a plane perpendicular to the axis of symmetry of the magnet pot 242. The side surfaces 247 form support surfaces for support in the recess 234.

In this embodiment, the shape of the recess 234 and the shape of the positioning element 246 are adapted to each other in such a way that when the magnet unit 240 approaches the coupling surface 232, the magnet unit 240 automatically positions itself in the orientation determined by the recess 234 and the positioning element 246 (also referred to as "self-centering"). This makes it possible to always position the holding device 220 or the magnet unit 240 in the predetermined orientation without effort.

In this embodiment, rotation of the magnet unit 240 about a rotational axis perpendicular to the coupling surface 232 of the coupling region 231 (in FIGS. 3A, 3B parallel to the x-axis) is prevented until the predetermined external force is applied to the magnet unit. Only when an external force greater than the predetermined value is applied can the magnet unit 240 be rotated about this rotational axis and/or can the magnetic coupling be released. Here, the side surfaces 247 form friction surfaces for shearing the magnet unit 240 from the coupling region 231.

The magnet unit 240 may be in contact with the contact surface 232 at three support points. The positioning element 246 or the two support surfaces 247 of the positioning element 246 form a support point. The magnet unit 240 may have two further support elements 248, each of which forms a support point. As shown, the support elements 248 are arranged on the end face 245 of the magnet pot 242. This allows for the magnet unit to be supported on the coupling surface in a manner that is stable against tilting.

According to the present disclosure, a nozzle unit for lateral shielding gas supply to a laser machining head is provided, wherein the shielding gas nozzle and/or the workpiece and/or the laser machining head are protected from damage in the event of a collision.

1. A nozzle unit for lateral shielding gas supply to a laser machining head, the nozzle unit comprising:
a shielding gas nozzle;
a holding device to which the shielding gas nozzle is attached; and
an adapter configured to attach the holding device to the laser machining head;
wherein the holding device and the adapter are detachably coupled to each other by magnetic force.

2. The nozzle unit according to claim 1, wherein a magnitude of the magnetic force is selected such that the adapter and the holding device detach from each other when a predetermined external force is applied.

3. The nozzle unit according to claim 2, wherein one of the adapter and the holding device is configured as a magnet unit, and the other of the adapter and the holding device is configured as a ferromagnetic unit.

4. The nozzle unit according to claim 3, wherein the magnet unit comprises a magnet and a magnet pot into which the magnet is inserted, and
wherein the ferromagnetic unit comprises a coupling region for magnetic coupling with the magnet unit.

5. The nozzle unit according to claim 4, wherein the magnet unit comprises a positioning element, and
wherein a shape of the coupling region and a shape of the positioning element are adapted to each other such that the magnet unit is coupled to the ferromagnetic unit in a predetermined orientation.

6. The nozzle unit according to claim 5, wherein the coupling region and the positioning element are shaped such and/or the magnitude of the magnetic force is selected such that:
rotation of the magnet unit about a rotational axis perpendicular to a coupling surface of the coupling region is prevented up to the predetermined external force, and/or
tilting of the magnet unit about an axis parallel to the coupling surface of the coupling region is enabled when an external force is applied.

7. The nozzle unit according to claim 4, wherein the coupling region is formed as a recess in the ferromagnetic unit,
wherein an edge of the magnet pot is inserted into the recess, and
wherein the edge of the magnet pot and/or the recess is not rotationally symmetrical.

8. The nozzle unit according to claim 5, wherein the positioning element is formed as a positioning lug on an end face of the magnet unit or the magnet pot, and
wherein the coupling region has a correspondingly shaped recess into which the positioning lug is inserted.

9. The nozzle unit according to claim 8, wherein the positioning lug protrudes prismatically from the end face.

10. The nozzle unit according to claim 8, wherein the positioning lug has two opposite side surfaces which each form an angle < 90° with a plane perpendicular to an axis of symmetry of the magnet pot and/or form support surfaces for support in the recess of the coupling region.

11. The nozzle unit according to claim 8, wherein the recess is open on a side corresponding to an outer side of the magnet pot; and/or
wherein the recess in the coupling region and the positioning lug on the end face are each formed at a position that is furthest down in a direction of gravity when the adapter and the holding device are attached to the laser machining head.

12. The nozzle unit according to claim 3, wherein the magnet unit is in contact with the ferromagnetic unit at three support points.

13. The nozzle unit according to claim 1, wherein the holding device further comprises a clamping device by which the shielding gas nozzle is detachably attached,
wherein the clamping device is adjustable to different diameters of the shielding gas nozzle.

14. The nozzle unit according to claim 13, wherein the clamping device comprises a first clamping element with a first V-shaped notch and a second clamping element with a second V-shaped notch, wherein the first notch and the second notch are opposite each other along a predetermined direction, and the first clamping element and the second clamping element are displaceable relative to each other along the predetermined direction in order to clamp the shielding gas nozzle between the first clamping element and the second clamping element.

15. A laser machining head comprising:
a housing; and
a nozzle unit according to claim 1,
wherein the adapter is attached to an outer side of the housing.
